(19) United States
(12) Patent Application Publication
(10) Pub. No.: US 2008/0133584 A1
(43) Pub. Date: Jun. 5, 2008

(54) Annotation management program, device, method and annotation display program, device, method

(75) Inventors: Fumihito Nishino, Kawasaki (JP); Terunobu Kume, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/983,067

(22) Filed: Nov. 7, 2007

(30) Foreign Application Priority Data
Dec. 5, 2006 (JP) 2006-327737

(51) Int. Cl. G06F 17/30

(52) U.S. Cl. 707/102; 707/E17.044

(57) ABSTRACT

Abstract of the Disclosure An annotation server stores annotation data sent from a web client into a first annotation database. The annotation server retrieves annotation data whose description information requires an execution result of a predetermined program from the first database, and incorporates the execution result of the predetermined program into the description information for the retrieved annotation data. Then, the computer transfers the data to the second database. Receiving a sending request for annotation data from a web client, the annotation server retrieves the annotation data from the second database and sends it to the web client that sent the request. Therefore, the web client displays the latest information as an annotation over a web page according to the annotation data received from the computer.

### BACKGROUND OF THE INVENTION

The present invention relates to a program, a device, and a method for managing annotation data, and to a program for displaying an annotation based on annotation data.

As everyone knows, an annotation in a book is information about an interpretation of a phrase in a body and information about a reference document that are described in a page corner or in a chapter end. On the other hand, an annotation in web page data is attendant information that is linked to a part (a character string, an image) in a web page without reference to a source text by a technique such as XLink (XML Linking Language).

With the annotation technique, an annotation server is introduced in a network apart from a web server, and a program for an annotation is installed into a web client as extension. When a part on a web page displayed by a web client program (a web browser) is selected and a description that should be linked to the selected part is inputted as an annotation, the extension concerned notifies the input description, the position information of the part linked to the description, and the location information of the web page data to the annotation server. The annotation server links the description, the position information, and the location information to each other, and registers them into an annotation database. When the web client acquires web page data from the web server, the extension concerned inquires about the presence or absence of annotation data linked to the web page. If the annotation exists, the extension acquires the annotation data from the annotation server and superimposes the annotation over the web page.

Japanese patent publication 3771831 and Japanese unexamined patent publication 2004-046745 disclose such a conventional annotation technique.

In the conventional annotation technique, a user at a web client side links static information to a part of a web page that cannot be edited at the web client side.

However, in such a technique, a user cannot display dynamic information such as stock quotations that vary by the hour on a part of a web page as an annotation that is linked to the web page.

### SUMMARY OF THE INVENTION

The present invention is developed in view of the above-mentioned problems in the prior art. An object of the present invention is to dynamically change a description of an annotation every time the annotation is displayed.

In order to achieve the above-mentioned object, an annotation management program of a first aspect according to the present invention controls a computer to execute functions including: a first storing function for storing annotation data, which includes location information about web page data, description information for specifying an annotation related with the web page corresponding to the web page data, and position information for specifying a position to which the annotation is linked on the web page, into a first database; a registration function for registering annotation data into the first database when the annotation data is received from any web client through a communication device; a retrieval function for retrieving annotation data whose description information requires an execution result of a predetermined program from the first database; a generation function for incorporating the execution result of the predetermined program into the description information for the retrieved annotation data; a second storing function for storing the processed annotation data and the remaining annotation data into a second database after the execution of the generation function; a receiving function for receiving a sending request for annotation data together with location information of web page data from a web client through the communication device; a retrieving function for retrieving annotation data corresponding to the location information received with the sending request from the second database when the receiving function receives the sending request; and a sending function for sending the annotation data retrieved by the retrieving function to the web client that sent the request through the communication device.

With this configuration, the computer retrieves annotation data whose description information requires an execution result of a predetermined program from the first database, and incorporates the execution result of the predetermined program into the description information for the retrieved annotation data. Then, the computer transfers the data to the second database. Further, when receiving a sending request for annotation data from a web client, the computer retrieves the annotation data from the second database and sends it to the web client that sent the request. Therefore, the web client displays the latest information as an annotation over a web page according to the annotation data received from the computer.

Accordingly, if a user of the web client registers annotation data whose description information requires an execution result of a predetermined program into the first database of the computer in advance, the latest information can be displayed over the web page.

In order to achieve the above-mentioned object, an annotation management program of a second aspect according to the present invention controls a computer to execute functions including: a storing function storing annotation data, which includes location information about web page data, description information for specifying an annotation related with the web page corresponding to the web page data, and position information for specifying a position to which the annotation is linked on the web page, into a database; a receiving function for receiving a sending request for annotation data together with location information of web page data from a web client through the communication device; a retrieving function for retrieving annotation data corresponding to the location information received with the sending request from the database when the receiving function receives the sending request; and a generation function for incorporating an execution result of a predetermined program into the description information for the annotation data whose description information requires an execution result of a predetermined program among the annotation data retrieved by the retrieving function; and a sending function for sending the annotation data processed by the generation function and the remaining annotation data to the web client that sent the request through the communication device.

With this configuration, when receiving a sending request for annotation data from a web client, the computer operates so as to retrieve the requested annotation data from the database. Further, the computer incorporates an execution result of a predetermined program into the description information for the annotation data whose description information requires an execution result of a predetermined program among the annotation data retrieved by the retrieving function, and then, the computer sends the data to the web client that sent the request. Therefore, the web client displays the latest information as an annotation over a web page according to the annotation data received from the computer. Accordingly, if a user of the web client registers annotation data whose description information requires an execution result of a predetermined program into the database of the computer in advance, the latest information can be displayed over the web page.

A program of the client side, which is complementarily related to the annotation management program according to the first or second aspect of the present invention mentioned above, may be a program to realize the conventional annotation extension in a web client, or may be a program to which a function to request the annotation data related with the same web page from the annotation management program concerned whenever a predetermined event occurs is added. The latter program can be considered as the following program.

Namely, in order to display annotations over a web page displayed by a web client, the program controls a computer to execute functions including: a first receiving function for receiving location information of the web page data for displaying the web page from the web client, a sending function for sending the location information received by the first receiving function and a sending request to an annotation server through a communication device whenever a predetermined event occurs, the annotation server having a database that manages annotation data, which includes location information of web page data, description information for specifying an annotation related with the web page corresponding to the web page data, and position information for specifying a position to which the annotation is linked on the web page; a second receiving function for receiving annotation data from the annotation server through the communication device as a response of the sending request sent by the sending function; and a display function for displaying the annotation over the web page concerned based on the annotation data received by the second receiving function.

With this configuration, the computer operates to re-acquire the annotation data related to the same web page from the computer on which the annotation management program according to the first or second aspect of the present invention mentioned above is running whenever a predetermined event occurs. Therefore, the computer updates the indication of the annotation whenever a predetermined event occurs.

Further, an annotation display program of the present invention, which is a different aspect from the first or second aspect mentioned above, displays an annotation over a web page displayed by a web client. In order to achieve the above-mentioned object, the annotation display program controls a computer to execute functions including: an acquisition function for acquiring annotation data including location information of web page data for displaying the web page concerned from an annotation server through a communication device, the annotation server having a database that manages annotation data, which includes location information of webpage data, description information for specifying an annotation related with the web page corresponding to the web page data, and position information for specifying a position to which the annotation is linked on the web page; a generation function for incorporating an execution result of a predetermined program into the description information for the annotation data whose description information requires an execution result of a predetermined program among the annotation data acquired by the acquisition function; and a display function for displaying the annotation over the web page concerned based on the annotation data processed by the generation function and the remaining annotation data.

With this configuration, the computer operates so as to acquire annotation data including location information of web page data for displaying a web page from the annotation server. Further, the computer incorporates an execution result of a predetermined program into the description information for the annotation data whose description information requires an execution result of a predetermined program among the annotation data acquired by the acquisition function, and then, the computer operates to display the annotations over the web page based on the annotation data. Therefore, the computer displays the latest information as an annotation over a web page according to the annotation data acquired from the annotation server. Accordingly, if a user of the computer registers annotation data whose description information requires an execution result of a predetermined program into the database of the annotation server in advance, the latest information can be displayed over the web page.

As explained above, the present invention can dynamically change a description of an annotation whenever the annotation is displayed.

### DESCRIPTION OF THE ACCOMPANYING DRAWINGS

FIG. 1 is a block diagram of a computer network system according to a first embodiment,

FIG. 2 is a flowchart showing a process by a generation module program,

FIG. 3 shows a concrete example of description information in annotation data,

FIG. 4 shows an example of a data structure of annotation data,

FIG. 5 is a flowchart showing processes concerning the inquiry about the presence or absence of an annotation at an annotation server side and at a web client side,

FIG. 6 is a flowchart showing processes concerning a display of an annotation at the annotation server side and at the web client side,

FIG. 7 is a flowchart showing a process by an update module program,

FIG. 8 is a flowchart showing a process by a description generation subroutine,

FIG. 9 is a block diagram of a computer network system according to a second embodiment,

FIG. 10 is a flowchart showing processes concerning a display of an annotation at the annotation server side and at the web client side,

FIG. 11 is a flowchart showing processes concerning a display update at the annotation server side and at the web client side,

FIG. 12 is a block diagram of a computer network system according to a third embodiment,

FIG. 13 is a flowchart showing processes concerning a display of an annotation at the annotation server side and at the web client side, and

FIG. 14 is a flowchart showing processes concerning a display update at the annotation server side and at the web client side.

### DESCRIPTION OF THE PREFERRED EMBODIMENTS

Hereafter, three embodiments of the present invention will be described with reference to the accompanying drawings.

### First Embodiment

First, a hardware configuration and a software configuration of the computer network system according to the first embodiment will be described.

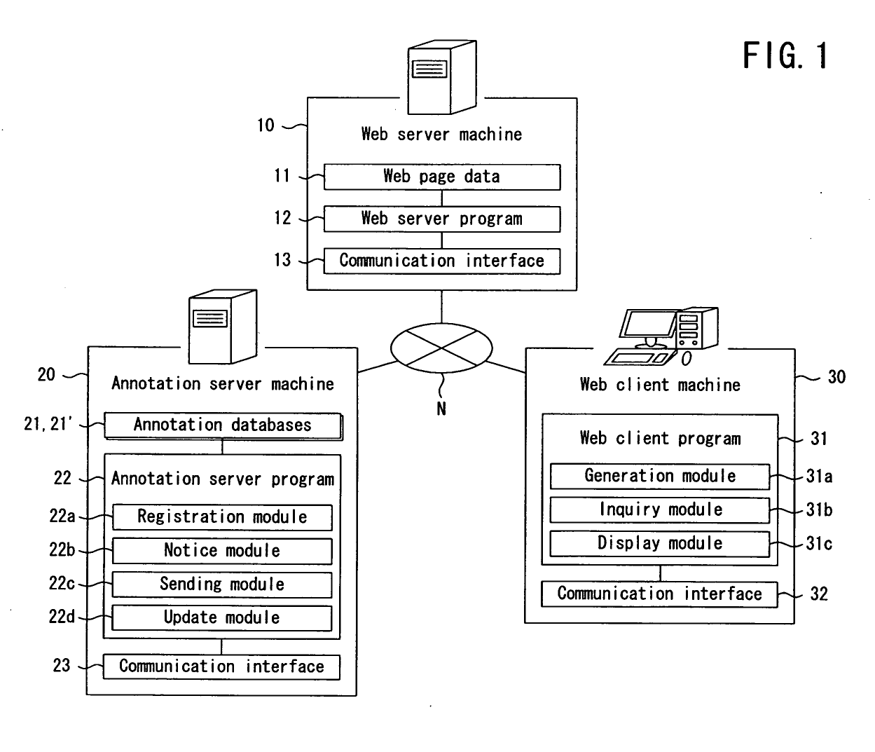

FIG. 1 shows the system configuration of the computer network system of the first embodiment.

The computer network system of the first embodiment consists of a web server machine 10, an annotation server machine 20, and a web client machine 30. The machines 10, 20, and 30 are connected via a network N so that they can communicate mutually.

The web server machine 10 is a general purpose computer to which a function as a web server is added.

Therefore, the web server machine 10 contains at least storage, a CPU, a DRAM, and a communication adapter that are not illustrated. The storage stores various kinds of application programs and data. The CPU is a processing unit that processes according to a program in the storage. The DRAM is a volatile memory device to which a program is cashed and workspace is developed when the CPU processes. The communication adapter is a communication device that exchanges data with other computers on the network N.

The storage of the web server machine 10 stores web page data 11, a web server program 12, and a communication interface program 13. The webpage data 11 is HTML (HyperText Markup Language) data that is provided to other computers through the network N. A unique URL (Uniform Resource Locator) is assigned to each the web page data 11 as location information. Receiving an HTTP (HyperText Transfer Protocol) request message with specification of URL from another computer on the network N, the web server program 12 sends an HTTP response message containing web page data 11 of the web page defined by the URL. The communication interface program 13 is a protocol stack (program) for exchanging the data with another computer through the network according to TCP/IP (Transmission Control Protocol/Internet Protocol).

The annotation server machine 20 is a general purpose computer to which a function of the annotation server is added. Therefore, the annotation server machine 20 contains at least storage, a CPU, a DRAM, and a communication adapter that are not illustrated.

The storage of the annotation server machine 20 stores two annotation databases 21 and 21′, an annotation server program 22, and a communication interface program 23. Here, an annotation is attendant information that is linked to a part (a character string, an image) in a web page without reference to a source text by a technique such as XLink (XML Linking Language). The first and second annotation databases 21 and 21′ are means for storing annotation data with enabling free search. A difference between the first annotation database 21 and the second annotation database 21′ will be described below. The annotation data includes at least location information (URL) of web page data, position information for specifying a position to which the annotation is linked on the web page, description information for specifying contents of the annotation, and information about generation of the description (a creator, a date and time of generation, etc.)

The position information included in the annotation data may be information that specifies routes and nodes of each of blocks related in a tree structure in a source text, like the information described according to Xpath (XML Path Language), for example. Alternatively, the position information may be a block ID (Identification) that is uniquely assigned to each block. Anyway, the annotation data uses the abstract information that logically specifies the position of an object (character string) to which the annotation is linked as the position information. The annotation server machine 20 that stores annotation data into the first annotation database 21 corresponds to the first storing function mentioned above. The annotation server program 22 is used to execute the process about annotation at the server side. The annotation server program 22 contains a registration module program 22a, a notice module program 22b, a sending module program 22c, and an update module program 22d. The registration module program 22a is used to store annotation data received from the web client machine 30 into the first annotation database 21. The notice module program 22b is used to notify the presence or absence of the annotation data that meets a predetermined condition in the first annotation database 21 in response to a request from the web client machine 30. The sending module program 22c is used to send annotation data from the second annotation database 21′ to the web client machine 30 in response to a request from the web client machine 30. The update module program 22d is used to update a record in the second annotation database 21′ based on the record in the first annotation database 21.

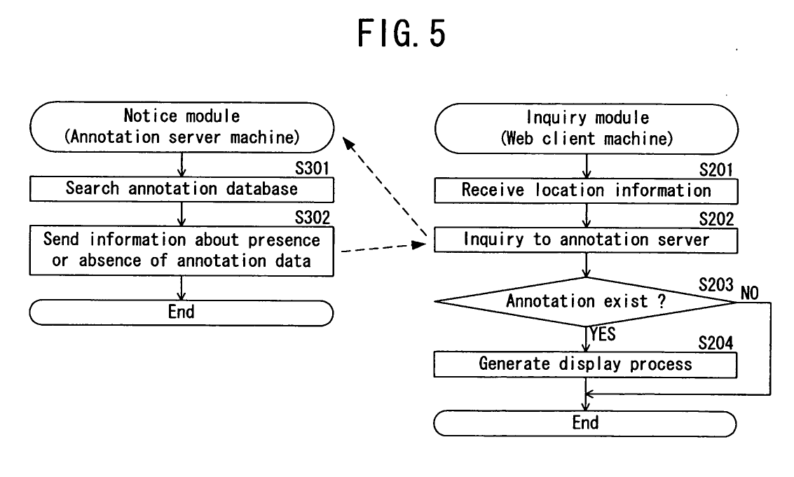

The processes executed by the CPU according to these programs 22a through 22d will be described below with reference to FIGS. 5 through 7. The communication interface program 23 is a TCP/IP stack as in the case of the web server machine 10.

The web client machine 30 is a personal computer to which the function of the web client is added. Therefore, the web client machine 30 consists of a display such as a liquid crystal display, input devices such as a keyboard and a mouse, and a main body to which these devices are connected. The main body contains storage, a CPU and a DRAM, and the communication adapter.

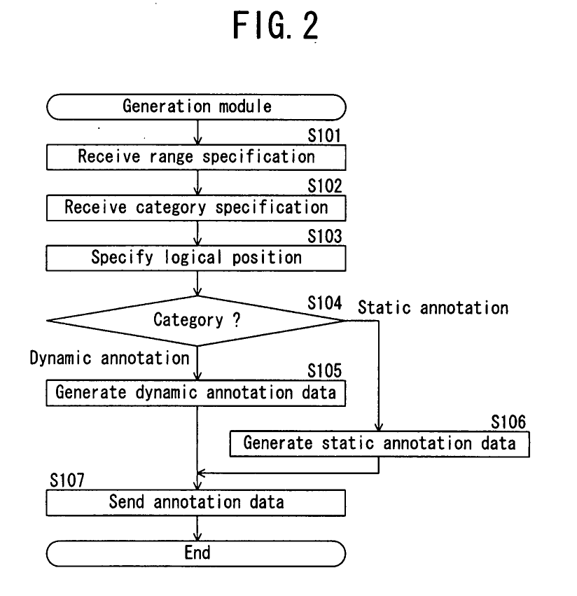

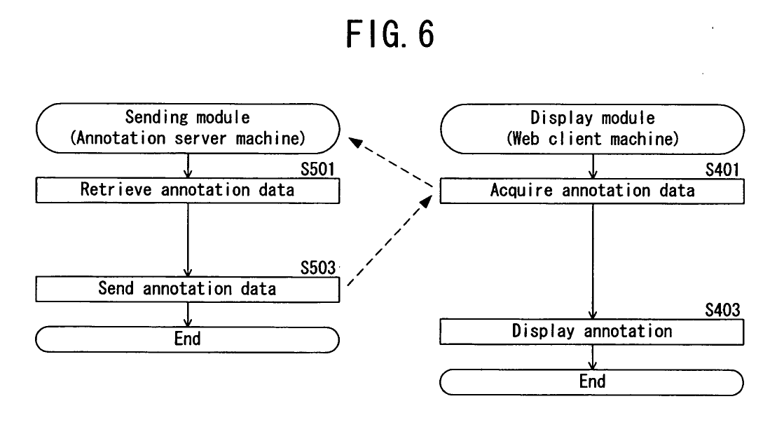

The storage of the web client machine 30 stores a web client program 31, and a communication interface program 32. The web client program 31 is used to acquire the web page data 11 in the web server machine 10 through the exchange of a HTTP message with the web server (function based on a program) 12, and to display the web page on the display. The web client program 31 contains a generation module program 31a, an inquiry module program 31b, and a display module program 31c as module programs for extensions. The generation module 31a is used to provide an annotation generation function for an operator and to deliver annotation data generated through the function to the registration module 22a of the annotation server program 22. The inquiry module program 31b is used to inquire whether the annotation data that meets a predetermined condition is registered after the notice module (function based on a program) 22b of the annotation server program 22. The display module program 31c is used to acquire annotation data from the sending module 22c and to display annotations over a web page. The processes executed by the CUP according to the programs 31a, 31b, and 31c will be described below with reference to FIG. 2, FIG. 5, and FIG. 6. The communication interface program 32 is a TCP/IP stack as in the case of the web server machine 10.

Next, the process concerning generation and registration of annotation data is described.

First, when a predetermined operation is inputted through the input device while the web client program 31 displays a web page on the display, the generation module program 31a starts.

FIG. 2 is a flowchart showing a process by the generation module program 31a.

In the first step S101, the generation module (the CPU (not shown) that executes the program) 31a receives an operator's specification of a position or a range to which an annotation is related, through a click operation or a drag operation for a part in a displayed web page, for example.

In the next step S102, the generation module 31a receives a category specification of an annotation that will be generated through a menu selection by an operator.

There are two categories for a dynamic annotation and a static annotation. The difference between a dynamic annotation and a static annotation will be described below.

In the next step S103, the generation module 31a specifies a logical position of the part (character string) on the web page specified by the range specification received in step S101. Specifically, the generation module 31a first specifies the respective blocks (the part sandwiched between a pair of tags of the same element like <body> and </body> is one block) that are related in a tree structure in a source text of the web page data. Then, the module 31a generates information that specifies each block (information to specify routes and nodes, or a block ID (Identification) that is unique for each block) to analyze the configuration of the web page data. Next, the generation module 31a specifies the block that is specified by the range specification received in step S101. Then, the module 31a defines the information that specifies the block as the target position information. The generation module 31a advances the process to step S104 after specifying the position information about the selected part to which the annotation is related.

In step S104, the generation module 31a determines whether the category of the annotation specified by the category specification received in step S102 is a dynamic annotation or a static annotation. When the category specified by the category specification received in step S102 is a dynamic annotation, the generation module 31a advances the process to step S105 from step S104.

In step S105, the generation module 31a generates description information for specifying contents of the annotation through operations like a menu selection, a text input, or drag and drop of a file by an operator. The description information generated here is not static information like a simple sentence (text), but dynamic information that changes content every time it is displayed.

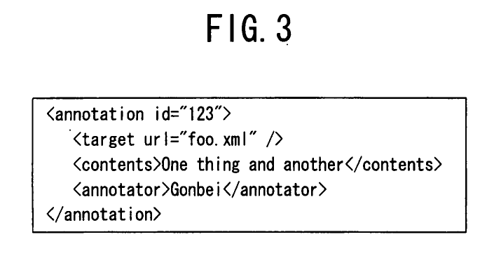

For example, the dynamic information is a program (script) that acquires stock quotations, exchange data, a weather bulletin, and sports information from other websites, a program that executes statistical works using a predetermined database, or executive instructions for these programs. Specifically, the description information of the dynamic annotation may consist of a program language name and a file name of an executable program such as “javascript:p= . . . ”, or may consist of location information of an executable program and a file name thereof such as “http://foo/cgi-bin/hoge.cgi”. Further, the description information of the dynamic annotation may be directly described in XML (eXtensible Markup Language) form as an example shown in FIG. 3, may be described using a special attribute such as <program language=“javascript”>p= . . . </program>, or may be expressed with an attribute such as <contents program=“ . . . ”/>. Anyway, since description information of a static annotation is a simple sentence (text), description information of a dynamic annotation may be any form that can be distinguished from that of a static annotation. The generation module 31a generates annotation data by linking the description information of such a dynamic annotation, the location information (URL) of the web page data to which the dynamic annotation is related, the position information about the logical position of the dynamic annotation on the related web page, and information about category specification. The description information is displayed as a simple text even if it is dynamic information as well as static information.

Therefore, the information about the category specification is effective to determine whether description information is dynamic information or static information. Creating the annotation data, the generation module 31a advances the process to step S107.

On the other hand, in step S104, when the category specified by the category specification received in step S102 is a static annotation, the generation module 31a branches the process from step S104 to step S106.

In step S106, the generation module 31a receives a content of a static annotation by an operator's input operation of a text, and generates the description information of the annotation data based on the received content. Then, the generation module 31a generates annotation data by linking the description information of such a static annotation, the location information (URL) of the web page data to which the static annotation is related, the position information about the logical position of the static annotation on the related web page, and information about category specification.

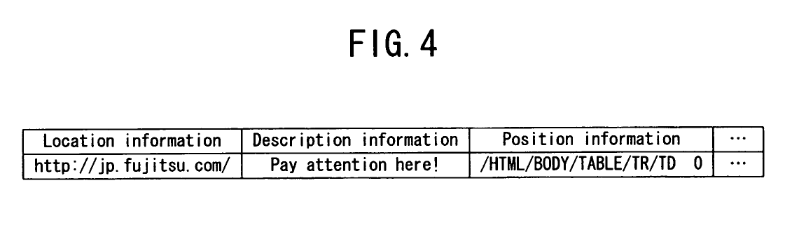

FIG. 4 shows an example of the data structure of the annotation data 31.

As shown in FIG. 4, the annotation data contains location information, description information, and position information at least. In FIG. 4, the location information is a URL. The position information of the annotation consists of data described by Xpath, and an offset that is the number of characters counted from the head to an object starting position in the block specified by the data. The annotation data may include date and time of generation of the annotation, a name of an annotator (a user who annotated), a size (the number of characters) of an object, or the like in addition to the above information.

Creating the annotation data as shown in FIG. 4, the generation module 31a advances the process to step S107.

At step S107, the generation module 31a sends the annotation data generated in step S105 or S106 to the annotation server (the CPU (not shown) that executes the program) 22. Then, the generation module 31a finishes the process shown in FIG. 2.

Receiving the annotation data from the generation module 31a as a trigger, the registration module 22a in the annotation server 22 starts itself and stores the received annotation data into the first annotation database 21. Thereby, the registration of the annotation is completed. The CPU (not shown) that executes the registration module 22a corresponds to the registration function mentioned above.

As described above, the annotation data is generated and is registered. A difference from the conventional technique is that information, which changes content every time it is displayed, such as a program itself and an executive instruction may be description information of an annotation. In the conventional technique, description information of an annotation is limited to static information such as a simple sentence that does not vary even if it is displayed again.

Next, a process concerning the inquiry module that inquires the presence or absence of an annotation will be described.

In the web client machine 30, when an instruction to display a web page is inputted to the web client (the CPU (not shown) that executes a program) 31, the inquiry module program 31b is started.

FIG. 5 is a flowchart showing processes concerning the inquiry about the presence or absence of an annotation at an annotation server side and at a web client side

The inquiry module (the CPU (not shown) that executes a program) 31b receives the location information (URL) of the web page that is a target to be displayed from the web client 31 in a first step S201. In parallel to the processes concerning FIG. 5, the web client 31 executes a process to acquire web page data from the web server 12 based on the location information.

In the next step S202, the inquiry module 31b inquires about the presence or absence of annotation data from the notice module 22b of the annotation server 22 based on the location information received from the web client 31. The inquiry module 31b waits until receiving a response from the notice module 22b.

In the annotation server machine 20, the inquiry as a trigger starts the notice module program 22b. The notice module (the CPU (not shown) that executes a program) 22b searches the first annotation database 21 for a record that meets the location information received together with the inquiry in step S301.

In the next step S302, the notice module 22b sends the information about the presence or absence of the annotation data that includes the same location information as the location information concerned to the inquiry module 31b as a response. And then, the notice module 22b finishes the process of FIG. 5.

On the other hand, in step S202, receiving the presence or absence of the annotation data that includes the same-location information as the location information sent together with the inquiry as a response from the notice module 22b, the inquiry module 31b advances the process to step S203.

In step S203, the inquiry module 31b determines whether the result of the inquiry in step S302 shows the presence of the annotation data or the absence thereof.

When the result of the inquiry shows the absence of the annotation data, the inquiry module 31b branches the process from step S203, and finishes the process of FIG. 5. In this case, the web client 31 only displays a web page.

On the other hand, when the result of the inquiry shows the presence of the annotation data, the inquiry module 31b advances the process to step S204.

In step S204, the inquiry module 31b starts the display module program 31c, generates the process of the display module 31c, and finishes the process of FIG. 5.

Next, the process for displaying an annotation will be described.

FIG. 6 is a flowchart showing processes concerning a display of an annotation at the annotation server side and at the web client side.

After the generation of the process of the display module 31c in step S204 mentioned above, the display module 31c acquires annotation data from the sending module 22c of the annotation server 22 in step S401. Specifically, the display module 31c receives the location information of the data of the web page that is currently displayed from the web client 31 first. Next, the display module 31c sends a sending request for annotation data together with the received location information of the web page data to the annotation server 22. Then, the display module 31c waits until receiving the annotation data as a response from the sending module 22c.

On the other hand, when the sending request for annotation data from the display module 31c is received, the annotation server 22 starts the sending module program 22c using the sending request as a trigger. The CPU (not shown) that executes the process for receiving the sending request corresponds to the receiving function mentioned above. The sending module (the CPU (not shown) that executes a program) 22c retrieves the annotation data including the received location information from the second annotation database 21′ in step S501. In the first embodiment, annotation data retrieved from the first annotation database 21 is not sent to the web client 31. The CPU (not shown) that executes the process in step S501 corresponds to the retrieving function mentioned above.

In the next step S503, the sending module 22c sends the retrieved annotation data to the display module 31c as a response, and then, finishes the process of FIG. 6.

The CPU (not shown) that executes the process in step S503 corresponds to the sending function mentioned above.

On the other hand, if receiving annotation data from the sending module 22c as a response to the sending request for annotation data, the display module 31c advances the process to step S403.

The display module 31c displays the annotation over the web page displayed by the web client 31 based on the received annotation data. Then, the display module 31c finishes the process shown in FIG. 6.

As described above, the annotation data is sent from the annotation server 22 to the web client, and the web client displays the annotation. A difference from the conventional technique is that annotation is retrieved from the second annotation database 21′ when the annotation data is sent to the display module 31c. That is, the annotation data is not retrieved from the first annotation database 21 in which the annotation data generated by the generation module 31a is stored.

Next, a process concerning the second annotation database 21′ will be described.

The annotation server machine 20 is executing the update module program 22d under a usual operating condition.

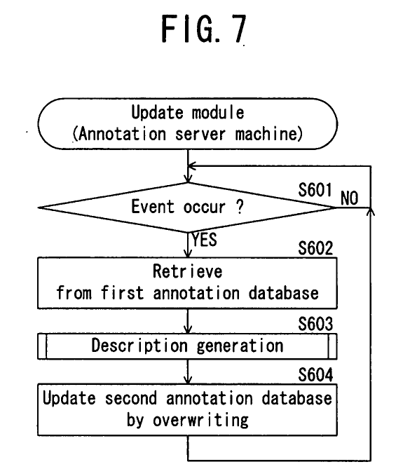

FIG. 7 is a flowchart showing a process by the update module program 22d.

In a first step S601, the update module (the CPU (not shown) that executes a program) 22d waits until a predetermined event occurs. The event is a lapse of fixed time, an arrival to a predetermined time, a specific operation, or the like. And when the predetermined event occurs, the update module 22d advances the process to step S602.

In step S602, the update module 22d retrieves all the records from the first annotation database 21.

In the next step S603, the update module executes a description generation subroutine.

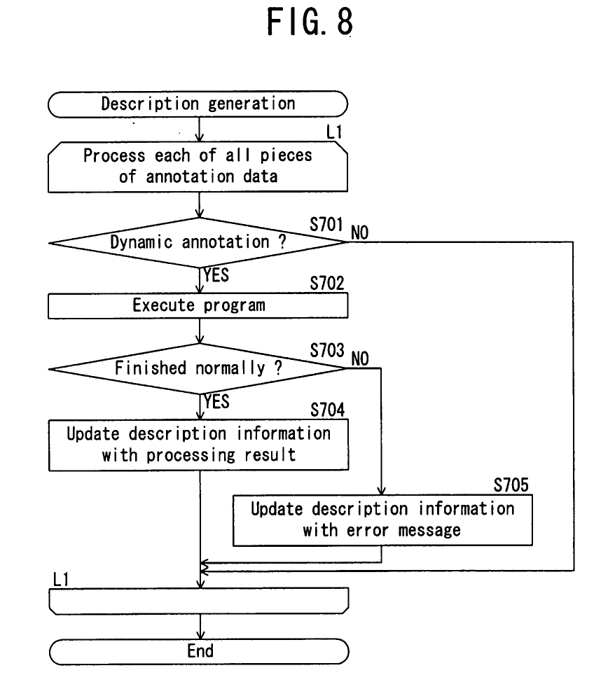

FIG. 8 is a flowchart showing a process by the description generation subroutine.

After starting the subroutine, the update module 22d executes a first process loop L1. In the first process loop L1, the update module 22d executes steps S701 through S705 for each of all pieces of the annotation data retrieved in step S602.

In step S701, the update module 22d determines whether the annotation concerning the annotation data of a processing target is a dynamic annotation. That is, the update module 22d determines whether the information about the category specification included in the annotation data of the processing target shows a dynamic annotation or a static annotation. And when the information about the category specification included in the annotation data of the processing target shows a static annotation, the update module 22d finishes the process for the annotation data of the current processing target. On the other hand, when the information about the category specification included in the annotation data of the processing target shows a dynamic annotation, the update module 22d advances the process to step S702.

In step S702, the update module 22d executes a program according to the description information of the dynamic annotation, and obtains a processing result.

In the next step S703, the update module 22d determines whether the process by the program concerned has been finished normally. And when the process by the program concerned has been finished normally, the update module 22d advances the process to step S704.

In step S704, the update module 22d updates the description information of the annotation data of the processing target by overwriting with the processing results obtained in step S702. Then, the update module 22d finishes the process about the annotation data of the processing target.

On the other hand, when the update module 22d determines that the process by the program concerned has been finished abnormally in step S703, the update module 22d advances the process to step S705.

In step S705, the update module 22d updates the description information of the annotation data of the processing target by overwriting with an error message, and finishes the process about the annotation data of the processing target.

When the update module 22d finishes the process of steps S701 through S705 with respect to all pieces of the annotation data retrieved in step S602 in FIG. 7, the update module 22d finishes the description generation subroutine of FIG. 8, and advances the process to step S604 in FIG. 7. The CPU (not shown) that executes the process in step S603 corresponds to the generation function mentioned above.

In step S604, the update module 22d updates the data stored in the second annotation database 21′ by overwriting with all pieces of the annotation data generated in step S603. The CPU (not shown) that executes the process in step S604 corresponds to the second storing function mentioned above. Then, the update module 22d returns the process to step S601 and waits until a predetermined event occurs.

Thus, when the annotation data that is transferred from the first annotation database 21 to the second annotation database 21′ is a dynamic annotation whose description information is a program or an executive instruction of a program, a processing result of execution of the program is reflected to the annotation data before the transfer (S603, S704), and then, is registered into the second annotation database 21′. The annotation data in the second annotation database 21′ is used to be sent to the web client machine 30.

Here, the content of the dynamic annotation is a program that acquires stock quotations etc., as described in the explanation about step S105 of FIG. 2. Therefore, the second annotation database 21′ stores the annotation data that includes the latest information as static information. Therefore, the display module 31c of the web client machine 30 can display the comparatively latest information as the annotation at the time of displaying.

Further, with just a registration of a dynamic annotation using the generation module 31a of the first embodiment, the user of the web client machine 30 can make the web client machine 30 display the latest information as an annotation.

In the first embodiment, although the notice module 22b is explained as what notifies the presence or absence of annotation data to the inquiry module 31b, the present invention is not limited to this. For example, the notice module 22b may send the annotation data itself detected from the annotation database instead of notifying the presence or absence of annotation data.

Further, although there are two annotation databases in the first embodiment, the present invention is not limited to this. For example, there may be only one annotation database. In the latter case, each record in the only-one annotation database should include a field for storing a processing result obtained by executing a process based on description information in addition to the fields for storing the location information, the position information, the description information, the information about generation, and the flag information that are sent from the web client. In such a case, the first and second annotation databases in the first embodiment can be physically combined into one.

Still further, the annotation server monitors an occurrence of an event as shown in step S601 in FIG. 7 in the first embodiment. However, the present invention is not limited to this. For example, the annotation extensions 31a through 31c of the web client 31 may request annotation data from the annotation server in response to an occurrence of an event in the web client. In the latter case, the display module 31c of the web client 31 can monitor an occurrence of an event after executing the process in step S403 in FIG. 6. Detecting an occurrence of an event, the display module 31a can send the sending request for the annotation data together with the location information to the annotation server 22, and then, can acquire the annotation data. In such a configuration, the web client machine 30 can update the displayed annotation whenever a predetermined event occurs in the first embodiment.

### Second Embodiment

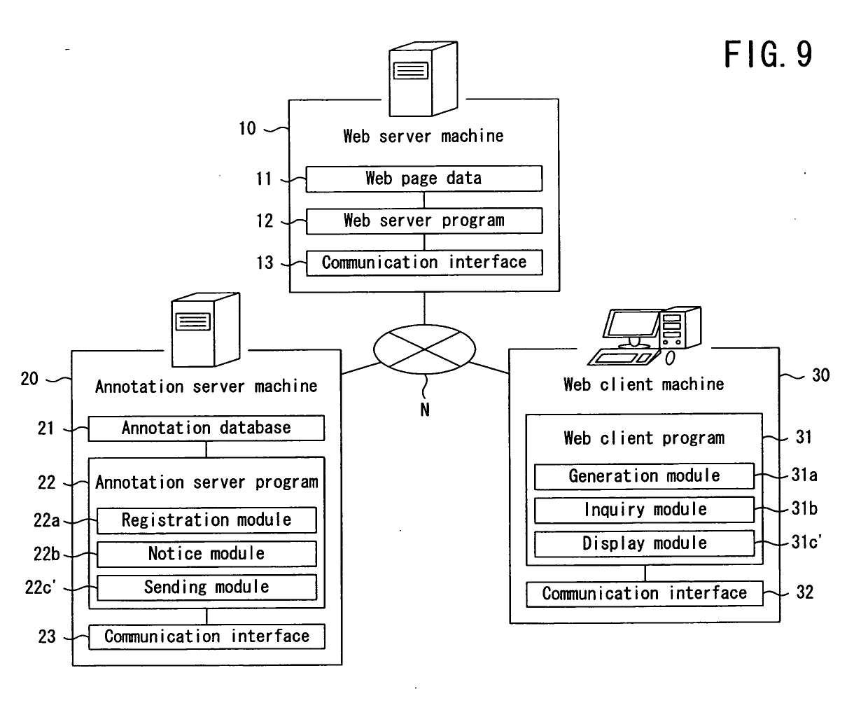

FIG. 9 shows the system configuration of the computer network system of the second embodiment.

In the second embodiment, the description generation process (S603 in FIG. 7) is executed at the server side whenever the display module 31c′ of the web client machine 30 sends a request. This is a difference from the first embodiment in which the description generation process executes whenever an event occurs. In connection with the difference, the second annotation database 21′ is unnecessary in the second embodiment. Therefore, as is evident from a comparison between FIG. 9 and FIG. 1, there is only one annotation database 21 in the second embodiment of FIG. 9. The annotation server program 22 does not include the update module program 22d. Instead of this, the sending module program 22c′ and the display module program 31c′ execute processes that are slightly different from those of the first embodiment. Therefore, reference letters that are assigned to the sending module program and the display module program are different from those in the first embodiment. However, the other configurations in hardware and software are basically identical to those of the first embodiment.

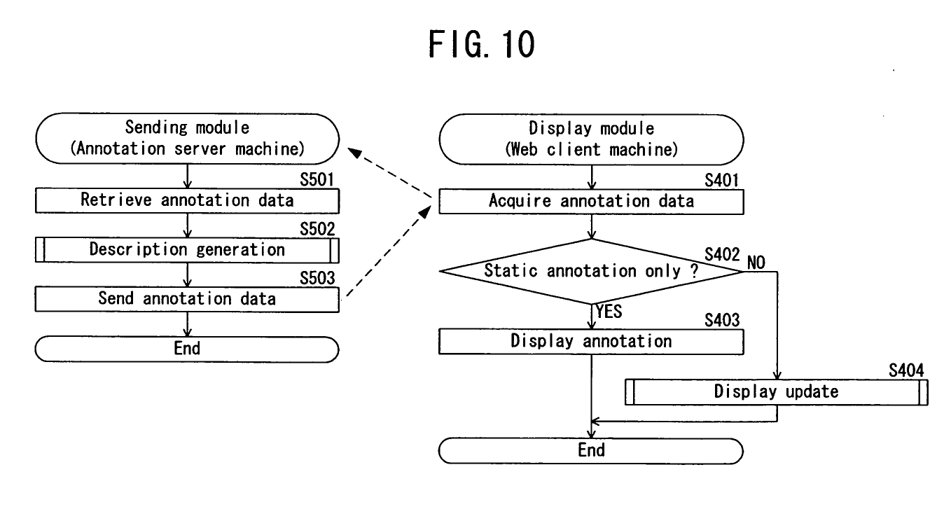

FIG. 10 is a flowchart showing processes concerning a display of an annotation at the annotation server side and at the web client side.

As is evident from a comparison between FIG. 10 and FIG. 6, the process of the sending module 22c′ includes step S502, and the process of the display module 31c′ includes steps S402 and S404 in the second embodiment of FIG. 10. These steps are not included in the processes in the first embodiment of FIG. 6.

In a first step S401 of the process, the display module 31c′ acquires annotation data from the sending module 22c′ of the annotation server 22. Specifically, the display module 31c′ receives the location information of the data of the web page that is currently displayed from the web client 31 first. Next, the display module 31c′ sends a sending request for annotation data together with the received location information of the web page data to the annotation server 22. Then, the display module 31c′ waits until receiving the annotation data as a response from the sending module 22c′.

On the other hand, when the sending request for annotation data from the display module 31c′ is received, the annotation server 22 starts the sending module program 22c′ using the sending request as a trigger. The CPU (not shown) that executes the process for receiving the sending request corresponds to the receiving function mentioned above. The sending module (the CPU (not shown) that executes a program) 22c′ retrieves the annotation data including the received location information from the second annotation database 21′ in step S501. The CPU (not shown) that executes the process in step S501 corresponds to the retrieving function mentioned above.

In the next step S502, the sending module 22c′ executes the description generation subroutine. The description generation subroutine is previously explained using FIG. 8. When the annotation data retrieved in step S501 is for a dynamic annotation whose description information is a program or an executive instruction of a program, the description information of the annotation data is updated by reflecting a processing result of an execution of the program. The CPU (not shown) that executes the process in step S502 corresponds to the generation function mentioned above.

In the next step S503, the sending module 22c′ sends the retrieved annotation data to the display module 31c as a response, and then, finishes the process of FIG. 6.

The CPU (not shown) that executes the process in step S503 corresponds to the sending function mentioned above.

On the other hand, if receiving annotation data from the sending module 22c′ as a response to the sending request for annotation data, the display module 31c′ advances the process to step S402.

In step S402, the display module 31c′ determines whether there is annotation data whose category specification shows a dynamic annotation among all pieces of the annotation data that are acquired in step S401. And when there is no annotation data whose category specification shows a dynamic annotation, the display module 31c′ advances the process to step S403.

In step S403, the display module 31c displays the annotation over the web page displayed by the web client 31 based on the received annotation data. Then, the display module 31c′ finishes the process shown in FIG. 10.

On the other hand, if there is annotation data whose category specification shows a dynamic annotation among all pieces of the annotation data that are acquired in step S401, the display module 31c′ branches the process from step S402 to step S404.

In step S404, the display module 31c′ executes the display update subroutine.

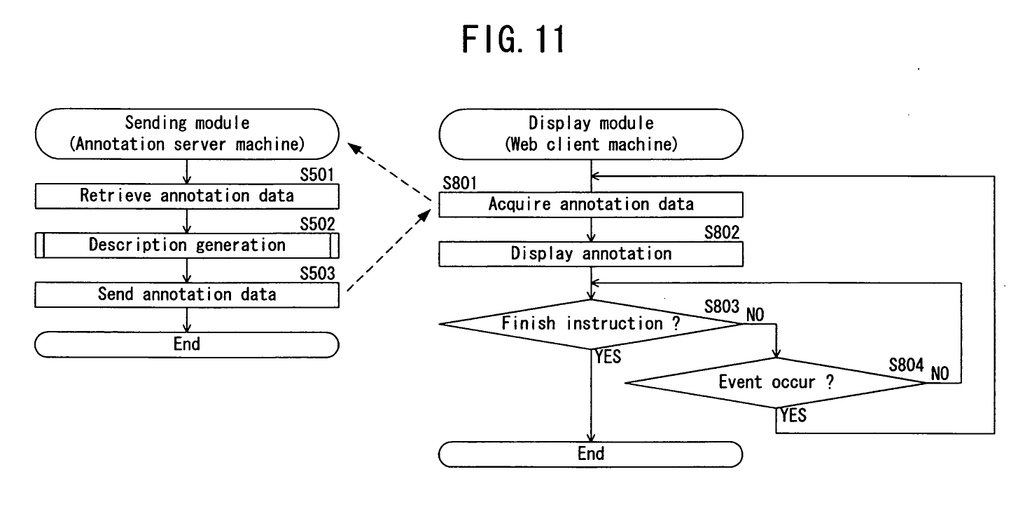

FIG. 11 is a flowchart showing processes concerning a display update at the annotation server side and at the web client side.

In a first step S801 of the subroutine, the display module 31c′ acquires annotation data from the sending module 22c′ of the annotation server 22. Specifically, the display module 31c′ sends a sending request for annotation data together with the location information of the data of the currently displayed web page to the annotation server 22. Then, the display module 31c′ waits until receiving the annotation data as a response from the sending module 22c′. As mentioned above, at this time, the sending module 22c′ retrieves annotation data including the received location information from the annotation database 21 (S501), updates the description information by reflecting the processing result of execution of the program in the dynamic annotation through the description generation subroutine (S502), and sends the annotation data to the display module 31c′ (S503). Receiving the annotation data from the sending module 22c′, the display module 31c′ advances the process to step S802.

In step S802, the display module 31c′ displays the annotation over the web page displayed by the web client 31 based on the received annotation data. Then, the display module 31c, advances the process to step S803.

In step S803, the display module 31c′ determines whether the finish instruction such as an instruction to close the window of the web client 31 occurred. And when there is no finish instruction, the display module 31c′ branches the process from step S803 to step S804.

In step S804, the display module 31c′ determines whether the predetermined event occurred. As described for step S601 of FIG. 7, the event is a lapse of fixed time, an arrival to a predetermined time, a specific operation, or the like. And when the predetermined event did not occurred, the display module 31c′ branches the process from step S804, and returns it to step S803.

During the execution of the process loop of steps S803 and S804, when the predetermined event has occurred, the display module 31c′ advances the process to step S801, and re-executes the annotation data acquisition process and the annotation display process.

During the execution of the process loop of steps S803 and S804, when the finish instruction is inputted, the display module 31c′ finishes the process of FIG. 11, and also finishes the process of FIG. 10.

As mentioned above, if the annotation data that is required by the display module 31c′ is a dynamic annotation whose description information is a program or an executive instruction of a program, the sending module 22c′ executes the program and reflects the processing result to the annotation data (S502, S704). And then, the sending module 22c′ delivers the annotation data to the display module 31c′.

Here, the content of the dynamic annotation is a program that acquires stock quotations etc., as described in the explanation about step S105 of FIG. 2. Therefore, the latest information at the time of display is linked with the web page as an annotation whenever the web page is displayed.

Further, the display module 31c′ requests annotation data from the sending module 22c when the predetermined event occurs (S804; YES, S801). Still further, the sending module 22c′ reflects the latest information to the annotation data of the dynamic annotation (S502), and delivers it to the display module 31c′. The display module 31c′ displays the annotation again (S802). Therefore, the annotation displayed over the web page is updated so as to include the latest information each time when an event occurs.

Further, with just a registration of a dynamic annotation using the generation module 31a of the second embodiment, the user of the web client machine 30 can make the web client machine 30 display the latest information as an annotation.

### Third Embodiment

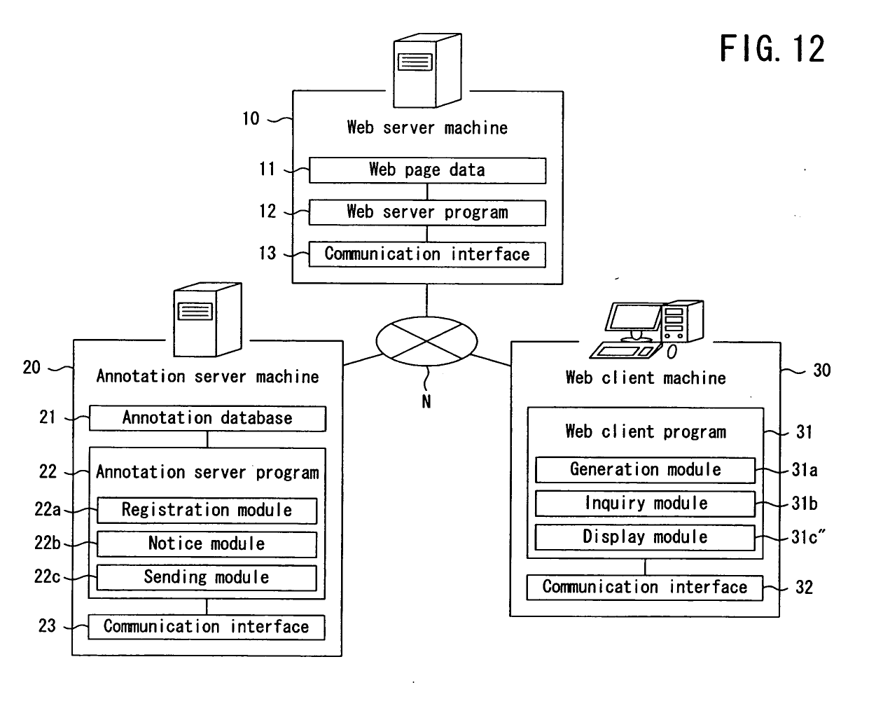

FIG. 12 shows the system configuration of the computer network system of the third embodiment.

In the third embodiment, the description generation process (S603 in FIG. 7 and S502 in FIGS. 10 and 11) is executed by the web client 31, not by the annotation server 22. This is a difference from the first and second embodiments. In connection with the difference, the second annotation database 21′ is also unnecessary in the third embodiment. Therefore, as is evident from a comparison between FIG. 12 and FIG. 1, there is only one annotation database 21 in the third embodiment of FIG. 12. The annotation server program 22 does not include the update module program 22d. Instead of this, the display module program 31c″ executes the process that is slightly different from that of the first and second embodiments.

Therefore, a reference letter that is assigned to the display module program in FIG. 12 is different from that in the first and second embodiments. The other configurations in hardware and software are basically identical to those of the first and second embodiments.

The sending module 22c of the third embodiment is also the same as that of the first embodiment.

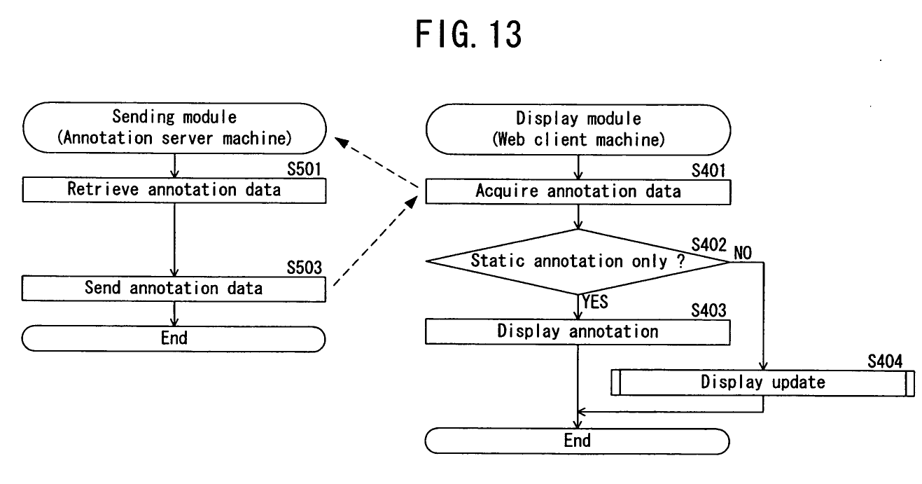

FIG. 13 is a flowchart showing processes concerning a display of an annotation at the annotation server side and at the web client side.

As is evident from a comparison between FIG. 13 and FIG. 10, the process of the sending module 22c does not include step S502 as in the case of the first embodiment.

On the other hand, the process of the display module 31c″ includes steps S402 and S404 as in the case of the second embodiment.

In the first step S401, the display module 31c″ acquires annotation data from the sending module 22c of the annotation server 22. Specifically, the display module 31c″ receives the location information of the data of the web page that is currently displayed from the web client 31 first. Next, the display module 31c″ sends a sending request for annotation data together with the received location information of the web page data to the annotation server 22. Then, the display module 31c waits until receiving the annotation data as a response from the sending module 22c. The sending module 22c that is started by the sending request as a trigger retrieves annotation data including the received location information from the annotation database 21 (S501), and sends the retrieved annotation data to the display module 31c″ (S503).

Receiving the annotation data from the sending module 22c, the display module 31c″ advances the process to step S402.

The CPU (not shown) that executes the process in step S401 corresponds to the first receiving function mentioned above.

In step S402, the display module 31c″ determines whether there is annotation data whose category specification shows a dynamic annotation among all pieces of the annotation data that are acquired in step S401. And when there is no annotation data whose category specification shows a dynamic annotation, the display module 31c″ advances the process to step S403.

In step S403, the display module 31c″ displays the annotation over the web page displayed by the web client 31 based on the received annotation data. Then, the display module 31c″ finishes the process shown in FIG. 13.

On the other hand, if there is annotation data whose category specification shows a dynamic annotation among all pieces of the annotation data that are acquired in step S401, the display module 31c″ branches the process from step S402 to step S404.

In step S404, the display module 31c″ executes the display update subroutine.

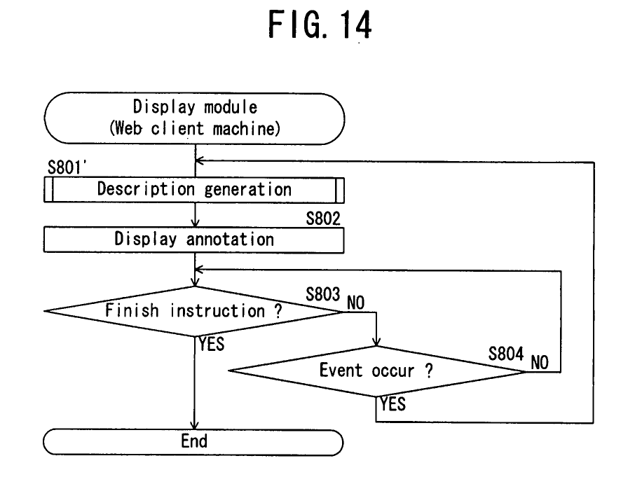

FIG. 14 is a flowchart showing processes concerning a display update at the annotation server side and at the web client side.

In a first step S801′ in the subroutine, the display module 31c″ executes the description generation subroutine.

The contents of the description generation subroutine were previously described using FIG. 8. When the annotation data acquired in step S401 is for a dynamic annotation whose description information is a program or an executive instruction of a program, the description information of the annotation data is updated by reflecting a processing result of an execution of the program. The CPU (not shown) that executes the process in step S801′ corresponds to the generation function mentioned above.

In step 802, the display module 31c displays the annotation over the web page displayed by the web client 31 based on the annotation data generated in step S801′ The CPU (not shown) that executes step S802 corresponds to the display function mentioned above. Then, the display module 31c″ advances the process to step S803.

In step S803, the display module 31c″ determines whether a finish instruction such as an instruction to close a window of the web client 31 was received. And when the event is not a finish instruction, the display module 31c″ branches the process from step S803 to step S804.

In step S804, the display module 31c″ determines whether the predetermined event occurred. As described for step S601 of FIG. 7, the event is a lapse of fixed time, an arrival to a predetermined time, a specific operation, or the like. If the predetermined event has not occurred, the display module 31c″ branches the process from step S804, and returns it to step S803.

If the predetermined event has occurred during the execution of the process loop of steps S803 and S804, the display module 31c″ returns the process to step S801′ to re-execute the description generation process and the annotation display process.

If a finish instruction is inputted during the execution of the process loop of steps S803 and S804, the display module 31c″ finishes the process of FIG. 14, and also finishes the process of FIG. 13.

As mentioned above, if the annotation data that is acquired by the display module 31c″ from the sending module 22c is a dynamic annotation whose description information is a program or an executive instruction of a program, the display module 31c″ executes the program and reflects the result to the annotation data (S801′, S704). And then, the display module 31c″ displays the annotation (S802).

Here, the content of the dynamic annotation is a program that acquires stock quotations etc., as described in the explanation about step S105 of FIG. 2. Therefore, the latest information at the time of display is linked with the web page as an annotation whenever the web page is displayed.

Further, when the predetermined event occurs, the display module 31c′ reflects the latest information of the dynamic annotation to the annotation data (S804; YES, S801), and displays the annotation again (S802). Therefore, the annotation displayed over the web page is updated so as to include the latest information each time when an event occurs.

Further, with just a registration of a dynamic annotation using the generation module 31a of the third embodiment, the user of the web client machine 30 can make the web client machine 30 display the latest information as an annotation.

What is claimed is:

1. A computer readable medium containing an annotation management program that controls a computer to execute functions comprising:
a first storing function storing annotation data, which includes location information about web page data, description information for specifying an annotation related with a web page corresponding to said web page data, and position information for specifying a position to which the annotation is linked on said web page, into a first database;
a registration function for registering annotation data into said first database when the annotation data is received from any web client through a communication device;
a generation function for incorporating an execution result of a predetermined program into the description information for the annotation data whose description information requires an execution result of a predetermined program among the annotation data stored in said first database;
a second storing function for storing the processed annotation data and the remaining annotation data into a second database after the execution of said generation function;
a receiving function for receiving a sending request for annotation data together with location information of web page data from any web client through said communication device;
a retrieving function for retrieving annotation data corresponding to the location information received with the sending request from said second database when said receiving function receives said sending request; and
a sending function for sending the annotation data retrieved by said retrieving function to the web client that sent the request through said communication device.

2. The computer readable medium according to claim 1, wherein said generation function executes its process whenever a predetermined event occurs.

3. An annotation management device comprising:
a first storing section storing annotation data, which includes location information about web page data, description information for specifying an annotation related with a web page corresponding to said web page data, and position information for specifying a position to which the annotation is linked on said web page, into a first database;
a registration section for registering annotation data into said first database when the annotation data is received from any web client through a communication device;
a generation section for incorporating an execution result of a predetermined program into the description information for the annotation data whose description information requires an execution result of a predetermined program among the annotation data stored in said first database;
a second storing section for storing the processed annotation data and the remaining annotation data into a second database after the execution of said generation section;
a receiving section for receiving a sending request for annotation data together with location information of web page data from any web client through said communication device;
a retrieving section for retrieving annotation data corresponding to the location information received with the sending request from said second database when said receiving section receives said sending request; and
a sending section for sending the annotation data retrieved by said retrieving section to the web client that sent the request through said communication device.

4. The annotation management device according to claim 3, wherein said generation section executes its process whenever a predetermined event occurs.

5. A computer readable medium containing an annotation management program that controls a computer to execute functions comprising:
a storing function for storing annotation data, which includes location information about web page data, description information for specifying an annotation related with the web page corresponding to the web page data, and position information for specifying a position to which the annotation is linked on the web page, into a database;
a receiving function for receiving a sending request for annotation data together with location information of web page data from a web client through a communication device;
a retrieving function for retrieving annotation data corresponding to the location information received with the sending request from said database when said receiving function receives said sending request;
a generation function for incorporating an execution result of a predetermined program into the description information for the annotation data whose description information requires an execution result of a predetermined program among the annotation data retrieved by said retrieving function; and
a sending function for sending the annotation data processed by said generation function and the remaining annotation data to said web client that sent the request through said communication device.

6. A computer readable medium containing an annotation display program for displaying an annotation over a web page displayed by a web client, said program controlling a computer to execute functions comprising:
a first receiving function for receiving location information of web page data for displaying said web page from said web client;
a sending function for sending said location information received by said first receiving function and a sending request for annotation data to an annotation server through a communication device whenever a predetermined event occurs, said annotation server having a database that manages annotation data, which includes location information of web page data, description information for specifying an annotation related with the web page corresponding to the web page data, and position information for specifying a position to which the annotation is linked on the web page;
a second receiving function for receiving annotation data from said annotation server through said communication device as a response of the sending request sent by said sending function; and
a display function for displaying the annotation over the web page based on the annotation data received by said second receiving function.

7. A computer readable medium containing an annotation display program for displaying an annotation over a web page displayed by a web client, said program controlling a computer to execute functions comprising:
an acquisition function for acquiring annotation data including location information of web page data for displaying the web page from an annotation server through a communication device, said annotation server having a database that manages annotation data, which includes location information of web page data, description information for specifying an annotation related with the web page corresponding to the web page data, and position information for specifying a position to which the annotation is linked on the web page;
a generation function for incorporating an execution result of a predetermined program into the description information for the annotation data whose description information requires an execution result of the predetermined program among the annotation data acquired by said acquisition function; and
a display function for displaying the annotation over the web page based on the annotation data processed by said generation function and the remaining annotation data.

8. The computer readable medium according to claim 7, wherein said generation function executes its process whenever a predetermined event occurs.
